(19) United States
(12) Patent Application Publication
(10) Pub. No.: US 2023/0295882 A1
(43) Pub. Date: Sep. 21, 2023

(54) RAIL TRANSPORT OVER-UNDER BYPASS SYSTEM FOR CONVEYING BULK MATERIALS

(71) Applicant: Rail-Veyor Technologies Global Inc., Lively (CA)

(72) Inventors: Russell Matthew Pietila, Hancock, MI (US); Tim Willard Wiitanen, Houghton, MI (US); James E Fisk, Antioch, IL (US); Carl Eric Kangas, Hancock, MI (US); William John McCall, Garson (CA); Luke Alan Daavettila, Hancock, MI (US)

(21) Appl. No.: 18/016,841

(22) PCT Filed: Jul. 19, 2021
(86) PCT No.: PCT/CA2021/050991

§ 371 Date: Jan. 18, 2023

Related U.S. Application Data
(60) Provisional application No. 63/054,053, filed on Jul. 20, 2020.

(51) Int. Cl. E01B 7/16; B61B 13/12; E01B 2/00

(52) U.S. Cl. CPC E01B 7/16; B61B 13/127; E01B 2/003

(57) ABSTRACT

A rail transport system having no internal drive is used for conveying bulk materials and includes an over-under bypass arrangement. The bypass arrangement includes drives, ramps and switches that allow trains to travel in both directions on two sets of tracks positioned above the same track footprint. Rail bypass arrangements for use with rail transport systems for conveying bulk materials and allowing bypass of a first train and a second train are also disclosed herein.

### CROSS-REFERENCE TO RELATED APPLICATION

This application claims priority to U.S. provisional patent application no. 63/054,053 filed Jul. 20, 2020, the entire contents of which is incorporated by reference.

### BACKGROUND OF THE INVENTION

### I. Field of the Invention

The present disclosure relates generally to a rail transport system having no internal drive, and in particular to over-under bypasses of a rail transport system for conveying bulk materials.

### II. Description of the Prior Art

Methods and arrangements for moving bulk materials in trucks, conventional trains, conveyor belts, aerial tramways or as a slurry in a pipeline are well known and are typically used in various industries due to site-specific needs and/or experience. In the minerals and aggregate industries, for example, bulk materials are moved from mining or extraction sites to a process facility for upgrading or sizing.

Trucks had been the system of choice for many years for moving such bulk materials. Typically, trucks were enlarged to be used for off-road vehicles because of their efficient transport of bulk materials and increased capacity. These vehicles, however, are limited to site specific applications and are provided at a high capital cost. Additionally, major off-road trucks have evolved that require very wide roadways for passing each other, are not energy efficient per ton-mile of material transported, have limited hill climbing ability, are dangerous because of potential of operator error and may be environmentally unpleasant.

Trains have also been used for many years for bulk material transport in hopper cars. The use of free rolling iron or steel on steel tracks are very efficient users of energy due to low friction but are limited in capacity relative to the drivers and/or locomotives required. Large tonnage long trains use multiple drivers that are heavy units, which dictate the weight of rail and ballast requirements. All railroads must be designed for the weight of the drivers and/or locomotives included fuel, and not necessarily the combination of the cars plus their loads, which are actually significantly less. The drivers need to be of sufficient weight so that the rotary drive tire makes contact with the stationary rail and must have sufficient friction to produce forward or reverse movement of what will include heavily loaded cars. The inclination capable of conventional railroad systems is limited to the friction between the weighted drive wheels and track. Additionally, rail cars are individual units that each has to be loaded in a batch process, one car at a time. Bulk materials can be unloaded from hopper cars by opening bottom dump hatches or can be individually rotated to dump out of the top. Spotting cars for both loading and unloading is time consuming and labor intensive. Although moving from one location to another may be cost effective, the added cost of batch loading and unloading stages in shorter distance transports reduces the rail transport cost effectiveness. Furthermore, with normal single dual track train systems only one train can be used on a system at a time.

Conveyor belts have also been used for many years to move bulk materials. A wide variety of conveyor belt systems exist that can move practically every conceivable bulk material. Short distance belts are commonly used in dry or damp transport of almost all types of materials. Very long-distance single belt runs are very cost intensive and are subject to catastrophic failure when a belt tears or rips, typically shutting down the entire system and dumping the carried load, requiring cleanup. While relatively energy efficient, conveyor belts can require high maintenance due to the inherent problem of multiple idler bearings that require constant checking and replacement. Because conveyor belts are very flexible and desirably operated over fairly flat terrain, they are not efficient at transporting moderately high solids slurry where water and fine particulate can accumulate in low spots and spill over the side creating wet spilled slurry handling problems.

Aerial tramways, also called material ropeways or ropeway conveyors are typically found around large mining concerns. A ropeway conveyor is essentially a subtype of gondola lift, from which containers for goods rather than passenger cars are suspended. While perhaps a necessity under certain terrain conditions, such tramways are more expensive to run than conveyor belt systems. They tend to have much spillage at the loading point and have high maintenance issues with their bucket gate mechanisms.

Lastly, some bulk materials can be transported in pipelines when mixed with water to form slurry that is pushed or pulled with a motor driven pump impeller in an airless or flooded environment. The size of the individual particles that are present in the bulk material dictates the transport speed necessary to maintain movement. For example, if large particles are present then the velocity must be high enough to maintain movement by saltation or skidding along the bottom of the pipe of the largest particles. Because pipelines operate in a dynamic environment, friction is created with the stationary pipe wall by a moving fluid and solid mass. The higher the speed of the moving mass the higher the friction loss at the wall surface requiring increased energy, and therefore increased costs, to compensate. Additionally, and depending on the application, the bulk material has to be diluted with water initially to facilitate transport and dewatering at the discharge end.

While the above methods and arrangements have their own specific advantages over other conventional systems, each is highly dependent upon a specific application. Accordingly, systems for transporting bulk material within multiple applications have been developed. In particular, light rail, narrow gage railroads systems offer an innovative alternative to the above-mentioned material transport systems. One such technology, the Rail-Veyor® material handling technology, has provided multiple successful systems, including control systems, drive stations, rail cars and dump loop systems.

In particular, U.S. Pat. Pub. No. 2018/0186384 to Fisk et al. describes a control system for an improved rail transport system for conveying bulk materials; U.S. Pat. No. 10,583,846 to Fisk et al. describes drive station arrangements; U.S. Pat. Pub. No. 2017/0320505 to Fisk et al. describes support frames and rail cars for conveying bulk materials on a rail transport system; and U.S. Pat. Pub. No. 2018/0127003 to Fisk et al. describes a rail transport dump loop system for conveying bulk materials, all of the disclosures of which are herein incorporated by reference in their entirety.

By way of example, the above-mentioned disclosures provide for the transport of bulk materials using a plurality of connected cars open at each end except for the first and last cars, which have end plates. The train forms a long open trough and has a flexible flap attached to each car and overlapping the car in front to prevent spillage during movement. The lead car has four wheels and tapered side drive plates in the front of the car to facilitate entry into the drive stations. The cars that follow have two wheels and a clevis hitch connecting the front to the rear of the car immediately forward. Movement of the train is provided by a series of appropriately placed drive stations having drive motors on either side of the track which are AC electric motors with drive means such as tires to provide frictional contact with the car side drive plates. At each drive station, each drive motor is connected to an AC inverter and controller for drive control, with voltage and frequency being modified as needed. The electric cars each turn a tire in a horizontal plane that physically contacts two parallel side drive plates external of the wheel of each car. Pressure on the side drive plates by these drive tires converts the rotary motion of the tires into horizontal thrust. The wheels on the cars are spaced to allow operation in an inverted position by use of a double set of rails to allow the cars to hang upside down for unloading. Flanged wheels may be symmetrical to the side drive plates allowing operation in an inverted position which, when four rails are used to encapsulate the wheel outside loop discharge of the bulk material is possible. By using elevated rails, the train can operate in the inverted position as easily as in the conventional manner. By rotating the double track system, the unit can be returned to the normal operating condition.

While light rail systems such as the Rail-Veyor® material handling systems described above are generally accepted, there is a need to provide a rail system having an over-under bypass and components thereof that permit trains to travel in both directions in a narrow space or generally within a single track footprint. It is accordingly a general object of this disclosure to provide same.

It is another general object of the present disclosure to provide a rail transport system for conveying bulk materials in both directions without the need for two full sets of tracks.

It is a more specific object of the present disclosure to provide a rail transport system for conveying bulk materials that can operate within a small application, for example within a drift of a mine.

It is still another more specific object of the present disclosure to provide a rail transport system for conveying bulk materials with minimal excavation for said system.

These and other objects, features and advantages of this disclosure will be clearly understood through a consideration of the following detailed description.

### SUMMARY OF THE INVENTION

According to an embodiment of the present disclosure, there is provided a bypass arrangement for use with a rail transport system without internal drives for conveying bulk materials. The bypass arrangement having one end coupled to a track used for extraction of materials and another end coupled to a track used for collection of materials. Two sets of rails are positioned between the ends of the arrangement and a drive station moves a first train through track switches along one of the tracks and a second train through track switches along the other track.

According to an embodiment of the present disclosure, there is provided a bypass arrangement that is configured for bidirectional movement of one or more trains with a reduced footprint. The narrower footprint may allow for greater clearance to drift walls in an underground mine for service vehicles or other vehicular traffic. It may also reduce the amount of excavation required in mines that have narrow drifts and require vehicular clearances.

According to an embodiment of the present disclosure, there is provided a rail bypass arrangement for use with a rail transport system for conveying bulk materials and allowing bypass of a first train and a second train. The rail bypass arrangement having a lower rail track having a downdrift (extraction) end and an updrift (collection) end, an upper rail track having a downdrift (extraction) end and an updrift (collection) end, an updrift track switch in communication with the updrift end of the lower rail track and the updrift end of the upper rail track, the updrift track switch comprising an actuator for guiding a train to either the upper rail track or the lower rail track, a downdrift track switch in communication with the downdrift end of the lower rail track and the downdrift end of the upper rail track, the downdrift track switch comprising an actuator for guiding a train to either the upper rail track or the lower rail track, and a first drive station positioned between the downdrift track switch and the updrift track switch for moving the first train on the lower track and a second drive station positioned between the downdrift track switch and the updrift track switch for moving the second train on the upper track.

According to an embodiment of the present disclosure, there is provided a rail bypass arrangement for allowing bypass of a first train and a second train. The rail bypass arrangement having a lower rail track having a downdrift (extraction) end and an updrift (collection) end, an upper rail track having a downdrift (extraction) end and an updrift (collection) end, an updrift track switch in communication with the updrift end of the lower rail track and the updrift end of the upper rail track, the updrift track switch comprising an actuator for guiding a train to either the upper rail track or the lower rail track, a downdrift track switch in communication with the downdrift end of the lower rail track and the downdrift end of the upper rail track, the downdrift track switch comprising an actuator for guiding a train to either the upper rail track or the lower rail track, and at least one drive station positioned between the downdrift track switch and the updrift track switch for moving the first train on the lower track and the second train on the upper track.

In some embodiments of the rail bypass arrangement, the updrift track switch has a side-by-side rail track junction of a dual rail track into a single rail track having a downdrift side and an updrift side, the updrift side having the single rail track, the downdrift side having the dual rail track, the dual rail track comprising an inward rail track in communication with the upper rail track and an outward rail track in communication with the lower rail track, the actuator situated for guiding an inward bound train from the single track to the inward rail track and permitting passage of an outward bound train from the outward track to the single track.

In some embodiments of the rail bypass arrangement, the rail bypass arrangement has a ramp rail track section in communication with the upper rail track and the inward rail track of the updrift switch, and a curved rail track section in communication with the lower rail track and the outward rail track of the updrift switch for side-by-side bypass of the ramp rail section, the curved rail track section having rail tracks curved to pass around the ramp rail section and below the upper track.

In some embodiments of the rail bypass arrangement, the downdrift track switch has a side-by-side rail track junction of a dual rail track into a single rail track having a downdrift side and an updrift side, the downdrift side having the single rail track, the updrift side having the dual rail track, the dual rail track comprising an inward rail track in communication with the upper rail track and an outward rail track in communication with the lower rail track, the actuator situated for guiding an outward bound train from the single rail track to the outward rail track and permitting passage of an inbound train from the inward track to the single track.

In some embodiments, the rail bypass arrangement has a ramp rail track section in communication with the upper rail track and the inward rail track of the downdrift switch, and a curved rail track section in communication with the lower rail track and the outward rail track of the downdrift switch for side-by-side bypass of the ramp rail section, the curved rail track section having rail tracks curved to pass around the ramp rail section and below the upper track.

In some embodiments, the updrift track switch has a lower rail track section having a downdrift end in communication with the updrift end of the lower rail track and an updrift end in communication with a single rail track, and an elevator ramp rail track section moveable between: an engaged position wherein a downdrift end of the ramp rail track section is in communication with the updrift end of the upper rail track and an updrift end of the ramp rail track section is in communication with the single rail track, and a disengaged position wherein the ramp is raised upward and disengaged from the single rail track at a height sufficient to allow the train to pass underneath the raised ramp section, and the ramp rail section moves between the engaged and disengaged positions via an elevating actuator in connection with the ramp section.

In some embodiments of the rail bypass arrangement, the elevating actuator is one or more of: a hydraulic, pneumatic, pulley, spring, gearing, electric, chain and sprocket, or magnetic actuator.

In some embodiments of the rail bypass arrangement, the downdrift track switch has a lower rail track section having an updrift end in communication with the downdrift end of the lower rail track and a downdrift end in communication with a single rail track, and an elevator ramp rail track section moveable between: an engaged position wherein an updrift end of the ramp rail track section is in communication with the downdrift end of the upper rail track and a downdrift end of the ramp rail track section is in communication with the single rail track, and a disengaged position wherein the ramp is raised upward and disengaged from the single rail track at a height sufficient to allow the train to pass underneath the raised ramp section, and the ramp rail section moves between the engaged and disengaged positions via an elevating actuator in connection with the ramp section.

In some embodiments of rail bypass arrangement, the elevating actuator is one or more of: a hydraulic, pneumatic, pulley, spring, gearing, electric, chain and sprocket, or magnetic actuator.

In other embodiments of the rail bypass arrangement, the updrift track switch has a lower rail track section having a downdrift end in communication with the updrift end of the lower rail track and an updrift end in communication with a single rail track, and a pivoting ramp rail track section moveable between: an engaged position wherein a downdrift end of the ramp rail track section is in communication with the updrift end of the upper rail track and an updrift end of the ramp rail track section is in communication with the single rail track, and a disengaged position wherein the updrift end is raised upward and disengaged from the single rail track at a height sufficient to allow a train to pass underneath the raised ramp section, and the ramp rail section is connected to the upper track section with a hinged or pivotal connection that allows movement between the engaged position and the disengaged position.

In further embodiments of the rail bypass arrangement, the movement is executed by one or more of: a hydraulic actuator, pneumatic actuator, pulley actuator, spring actuator, gearing actuator, electric actuator, chain and sprocket actuator, or magnetic actuator.

In some embodiments of the rail bypass arrangement, the downdrift track switch has a lower rail track section having an updrift end in communication with the downdrift end of the lower rail track and a downdrift end in communication with a single rail track, and a pivoting ramp rail track section moveable between: an engaged position wherein an updrift end of the ramp rail track section is in communication with the downdrift end of the upper rail track and a downdrift end of the ramp rail track section is in communication with the single rail track, and a disengaged position wherein the downdrift end is raised upward and disengaged from the single rail track at a height sufficient to allow a train to pass underneath the raised ramp section, and the ramp rail section is connected to the upper track section with a hinged or pivotal connection that allows movement between the engaged position and the disengaged position.

In further embodiments of the rail bypass arrangement, the movement is executed by one or more of a hydraulic actuator, pneumatic actuator, pulley actuator, spring actuator, gearing actuator, electric actuator, chain and sprocket actuator, or magnetic actuator.

According to an embodiment of the present disclosure, there is provided a bypass arrangement for use with a rail transport system having no internal drive for conveying bulk materials, the arrangement having a first end communicating with a rail track used for extraction site transport and a second track communicating with a rail track used for collection site transport, a lower rail track between said first and second ends, an upper rail track between said first and second ends, a first end track switch mechanism and a second end track switch mechanism, and a first drive station positioned between said ends for moving a first train through said switch mechanisms on said lower track and a second drive station positioned between said ends for moving second train through said switches on said upper track.

According to an embodiment of the present disclosure, there is provided a bypass arrangement for use with a rail transport system having no internal drive for conveying bulk materials, the arrangement having a first end communicating with a rail track used for extraction site transport and a second track communicating with a rail track used for collection site transport, a lower rail track between said first and second ends, an upper rail track between said first and second ends, a first end track switch mechanism comprising a first end elevator ramp rail track section, a second end track switch mechanism comprising a second end elevator ramp rail track section, and a first drive station positioned between said ends for moving a first train under the elevator ramp rail track sections on said lower track and a second drive station positioned between said ends for moving a second train through said elevator ramp rail track sections on said upper track. In some embodiments, the bypass arrangement has one drive station for the lower track and one drive station for the upper track. In such embodiments and others, the first and second drive stations may be referred to as a bypass dual drive station.

According to an embodiment of the present disclosure, there is provided a bypass arrangement for use with a rail transport system having no internal drive for conveying bulk materials, the arrangement having a first end communicating with a rail track used for extraction site transport and a second track communicating with a rail track used for collection site transport, a lower rail track between said first and second ends, an upper rail track between said first and second ends, a first end track switch mechanism comprising a first end pivoting ramp rail track section, a second end track switch mechanism comprising a second end pivoting ramp rail track section, and a first drive station positioned between said ends for moving a first train on said lower track and a second drive station positioned between said ends for moving a second train on said upper track. In some embodiments, the bypass arrangement has one drive station for the lower track and one drive station for the upper track. In some embodiments a dual drive station may be used which spans both the lower and upper tracks and comprises two drive tires, one for driving a train on the lower track and one for driving a train on the upper track and in an opposite direction.

In some embodiments, the upper rail track is adapted to accommodate an inward or unloaded train, and the lower rail track is adapted to accommodate the outward or loaded train. the upper rail track and the lower rail track are each about 1.5 times longer than a length of a train for using the bypass.

In some embodiments, the actuators and/or the switches are controlled by a program logic controller (PLC). In further embodiments, the program logic controller also controls the operation of the drive stations to control the speed of the trains in the system.

In some embodiments, the first drive station and the second drive station are comprised in a dual drive station. In further embodiments, the dual drive station is an integrated dual drive station with the first and second drive stations mounted vertically above one another.

According to an embodiment of the present disclosure, there is provided a rail transport system for conveying bulk materials on a rail track having a first train, a second train, and a bypass arrangement as described above for permitting the first train to bypass the second train on an upper and a lower track of the bypass arrangement.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a diagrammatical illustration of an embodiment of a rail transport system for conveying bulk materials;

FIG. 2 is a side view of one embodiment of a train, comprising rail cars, operable with the rail transport system of FIG. 1;

FIG. 3 is a top plan view of one embodiment of a train, comprising rail cars, operable with the rail transport system of FIG. 1;

FIG. 4 is a diagrammatical illustration of a general arrangement of an over-under bypass of a rail transport for conveying bulk materials according to the principles of an embodiment of the present disclosure;

FIG. 5 is a top plan view of the updrift track switch of the bypass of FIG. 4;

FIGS. 6A-C are top plan, side elevation and perspective views, respectively, of a side-by-side embodiment of the updrift end ramp of the bypass of FIG. 4;

FIG. 7 is a perspective view of the bypass drive station of FIG. 4;

FIG. 8 is a perspective view of the bypass dual drive station of FIG. 4;

FIGS. 9A-C are top plan, side elevation and perspective views, respectively, of a side-by-side embodiment of the downdrift end ramp of FIG. 4;

FIG. 10 is a top plan view of the downdrift track switch of FIG. 4;

FIGS. 11A-B are perspective views of an elevator ramp embodiment of the updrift end ramp of the bypass of FIG. 4 in an engaged position (FIG. 11A) and a disengaged position (FIG. 11B), and

FIGS. 12A-B are perspective views of a pivoting ramp embodiment of the updrift end ramp of the bypass of FIG. 4 in an engaged position (FIG. 12A) and a disengaged position (FIG. 12B).

### DETAILED DESCRIPTION

The present disclosure will now be described more fully hereinafter with reference to the accompanying drawings, in which illustrative embodiments of the invention are shown. The disclosure may, however, be embodied in many different forms and should not be construed as limited to the embodiments and examples set forth herein nor should the disclosure be limited to the dimensions set forth herein. Rather, the embodiments herein presented are provided so that this disclosure will be thorough and complete and will fully convey the scope of the disclosure to those skilled in the art by way of these illustrative and non-limiting embodiments and examples. It will be understood to the person of skill in the art that many different forms and variations of the embodiments, examples and illustrations provided herein may be possible, and the various embodiments, examples, and illustrations provided herein should be construed as non-limiting embodiments, examples, and illustrations. Accordingly, one or more embodiments of the subject disclosure will now be described with the aid of numerous drawings. Unless otherwise indicated, use of specific terms will be understood to include multiple versions and forms thereof.

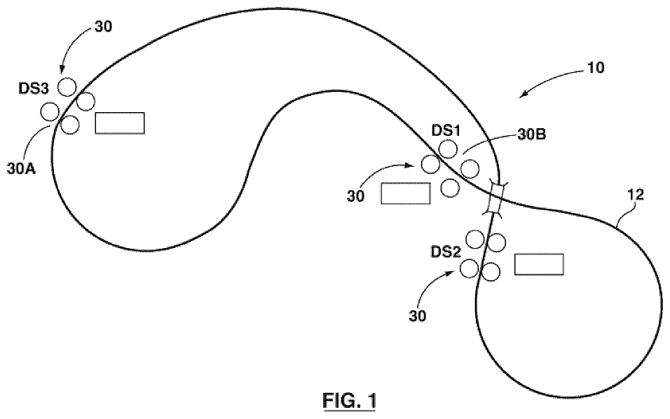

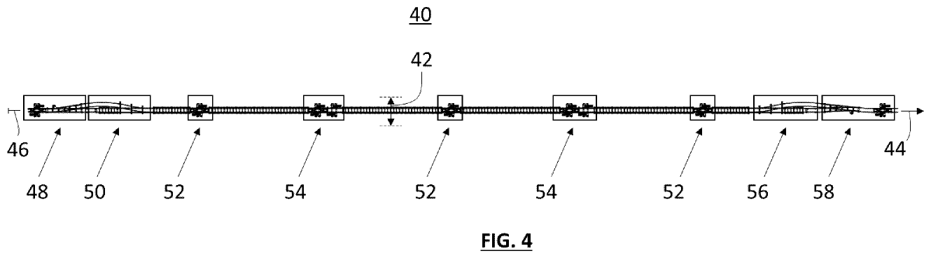

With reference initially to FIGS. 1-3, one train and rail transport system 10, in keeping with the teachings of the present invention, comprises a track 12 having parallel rails 12a, 12b. A train 14 includes a first, front or lead car 16 having both forward and rear wheel pairs 18, 20 operable on the track 12 for providing a free wheeling movement to the lead car. For the embodiment herein described by way of example, the train includes additional cars described as a second or rear car 22 and an intermediate or middle rail car 24 or multiple intermediate or middle rail cars, carried between the lead and rear cars. The rear and intermediate cars 22, 24 include a forward pivotal connection or coupling assembly 26 for pivotally connecting the intermediate and rear cars to adjacent forward cars. The rear and intermediate cars 22, 24 have only rear wheel pairs 20 operable on the track 12 for providing a freewheeling movement thererto. The track 12 may include an over-under bypass arrangement for permitting trains to travel in both directions in a limited space or generally confined by a single track area. For example, the over-under bypass arrangement may be used in sections of track that are at least partially above ground. In some cases, the over-under bypass arrangement may be used in sections of track that are at least partially below or completely under ground, for example within a drift of a mine. The bypass section and components thereof will be discussed in more detail below with reference to FIGS. 4-12.

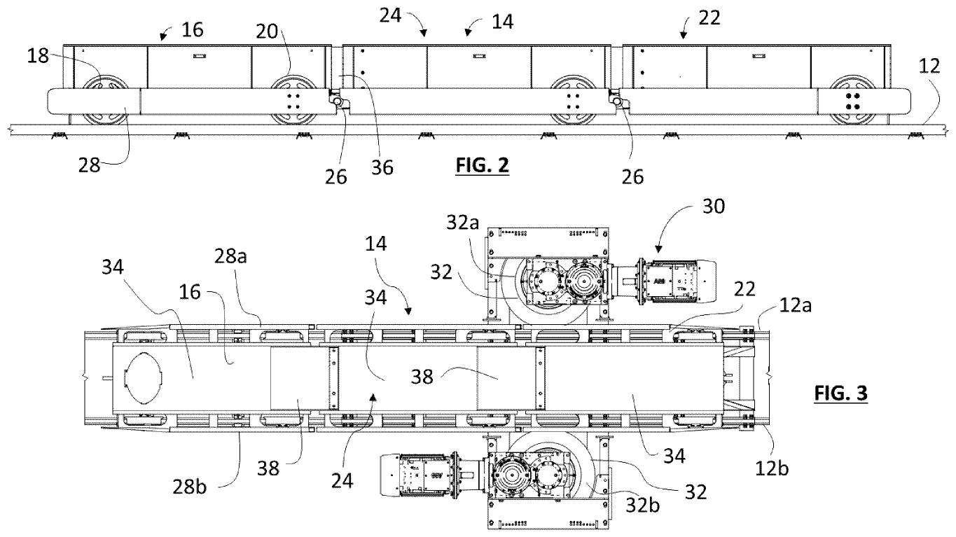

With continued reference to FIG. 2, each of the cars has a side plate 28 affixed thereto. With reference to FIGS. 1 and 3, multiple drive stations 30 each have a variable frequency drive (VFD) including a drive tire 32 for frictionally contacting the side plate and imparting a driven moment to each rail car and thus the train 14. As illustrated with continued reference to FIG. 3, the embodiment herein described includes each car having opposing side plates 28a, 28b and opposing drive tires 32a, 32b. Specifically, each car may have a fixed side plate on each side, which runs substantially the length of the car and spaced outside the wheels and tracks. These side plates may be located symmetrically with the wheels and parallel to the light rails. In another arrangement, the side plates may be located asymmetrical with the wheels. However, in this arrangement, the wheels are part of the side plates such that the side plate-wheel arrangement allows the train to be moved either downstream or upstream. The wheels may be placed to allow the train to operate in either an upright or an inverted position. Each drive station 30 includes A/C inverters and a controller connected to every set of drive motors such that the motors may be synchronized through a modifying of at least one of voltage and frequency thereto. Forward or reverse motion of the train is the result of horizontal rotation of tires on opposite sides of the train turning in opposite directions with suitable pressure of said rotation that provides reduced slip between the tire surface and side plates. In other words, the two opposing tires are both pushed inward toward the center of the track. In order to stop the train, the drive tires 32 are further adapted to engage and apply pressure to the side plate 28 of the car.

As herein illustrated, the lead car 16 has a trough 34 and opposing side plates 28a, 28b having a reduced distance between them for smooth entrance into opposing drive tires 32a, 32b of the drive station. The rear car 22 has a trough and opposing side plates 28a, 28b which may be at a reduced distance between them to reduce shock when the train 14 exits the opposing drive tires 32a, 32b of the drive station 30. The intermediate cars 24 coupled to the lead car 16 and the rear car 22 by the clevis type coupling has its trough aligned to produce an overall open trough with gaps 36 between cars. A flexible flap 38 extends over the gap 36 between cars 16, 24, 22. The cars, each comprise of a semi-circle open trough and when joined or coupled together represents an open and continuous rigid trough for the entire length of the train. A flexible sealing flap attached near the front of the trailing car overlaps but is not attached to the rear of the lead car trough. A semi-circular trough is better sealed with the flexible flap than other designs (i.e. U.S. Pat. No. 3,752,334). This allows the train to follow the terrain and curves without losing its sealed integrity as continuous trough. The material to be transported in the train is effectively supported and sealed by this flap as the material weight is equally distributed maintaining the seal against the metal trough of the forward car. The long continuous trough can provide for simplified loading as the train can be loaded and unloaded while moving similar to a conveyor belt. This can be considered an advantage over the batch loading equipment requirements of a conventional railroad hopper or rotary dump car. It will be appreciated that any suitable car and/or drive station may be used within the rail systems and bypasses disclosed herein provided the suitable car can be driven by a suitable drive station.

As mentioned above, the track 12 can include an over-under bypass arrangement for permitting trains to travel in both directions on a single track. An example of such an arrangement is shown in the diagrammatical illustration of FIG. 4. It will be understood that the over-under bypass track section arrangement 40 can be positioned, as necessary, anywhere along the rail transport system. Indeed, there may be more than one such arrangement within such system. For example, one near a mountainous overpass on the way to an ore mine, another as the track makes its way over a bridge traversing a waterway on the way to a dump area, within a drift in a mine, or at any suitable or desirable position along the rail transport system where a bypass is needed and where a reduced footprint for that bypass is required or preferred.

It will be understood by a person of skill in the art that the term “drift” generally refers to any suitable horizontal or sub-horizontal openings in a mining application. For example, a drift may take the form of a tunnel carved out of rock. Such drifts may have an excavation/extraction end, located deep in the mine at or near a source of mining material (such as ore), and an opposing collection end, located at or near a surface of the mine. Updrift may be used to describe a direction generally towards the material collection end 46 of the drift. Downdrift may be used to describe a direction generally towards the extraction end 44 of the drift. In addition, reference to an inward direction of travel refers to a direction from the updrift, surface or exterior side of the drift or mine towards the downdrift side or toward the excavation/extraction side. Reference to an outward direction of travel refers to a direction from the downdrift or excavation/extraction side to the updrift, surface or exterior side. Typically, a rail car moving outward would be loaded with mining material, while a rail car moving inward would be empty. It will be understood by a person of skill in the art that the relative orientation of the bypass arrangement shown in the Figures is for illustrative purposes and may be changed. For example, the updrift ramp may be used in a downdrift orientation with relatively minor modification.

The general arrangement 40 of FIG. 4 is one example of using a minimal or reduced amount of space/area/footprint 42 for trains to bypass each other on their way to/from an ore pass 44 or other extraction site and a dump area 46 or other collection site. It will be appreciated that the footprint as labeled in FIG. 4 is for illustration purposes only and may be proportionally larger or smaller than depicted. Indeed, while the remainder of this description will depict one track positioned atop another, it will be appreciated that portions of the two tracks may need to be positioned side by side (such as when a horizontal switch is implemented) or not directly above each other, such as offset, if the shape of the local topography or drift demands such.

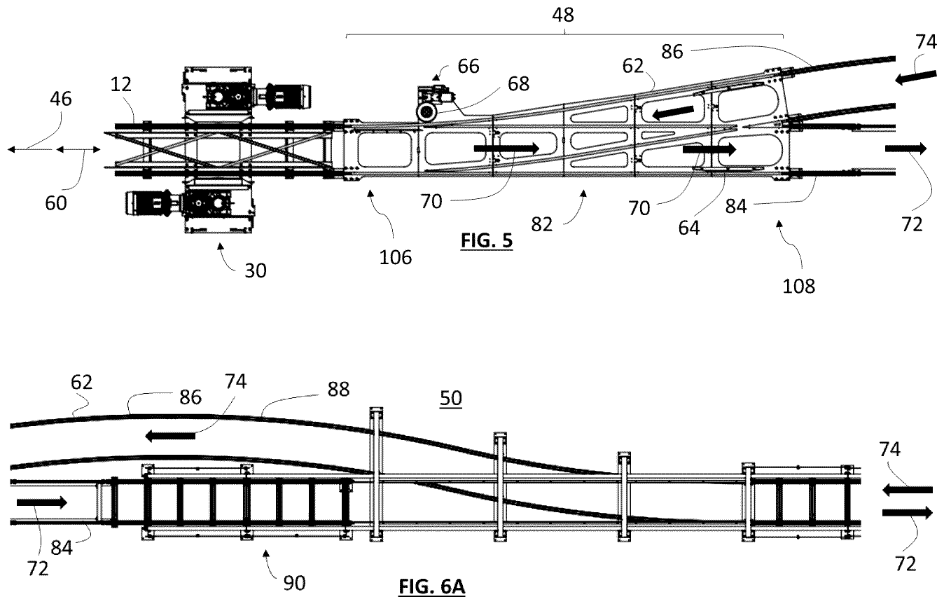

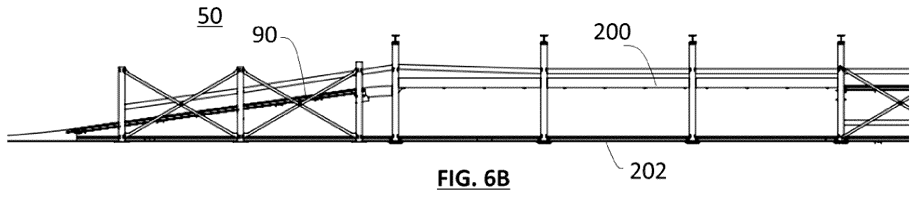

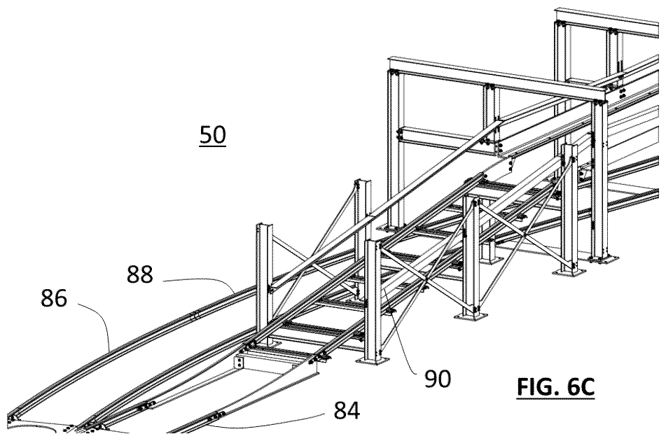

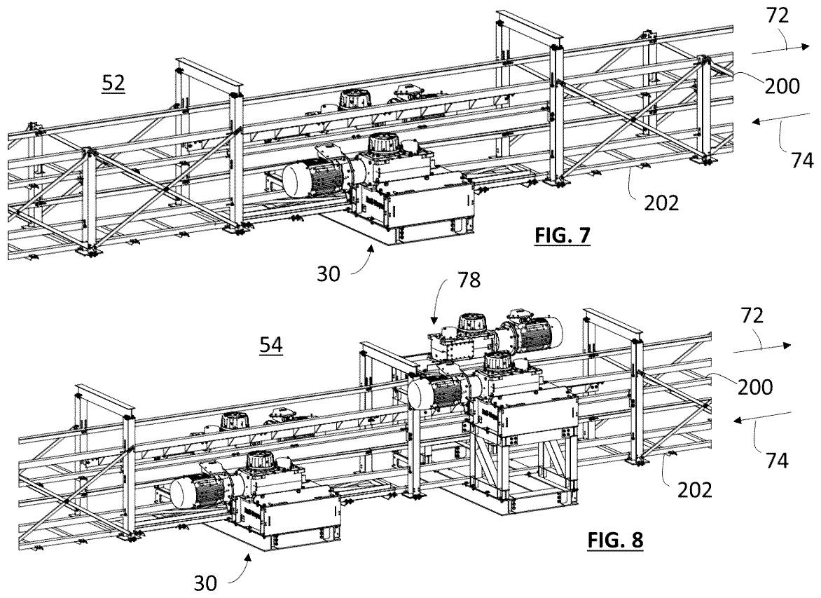

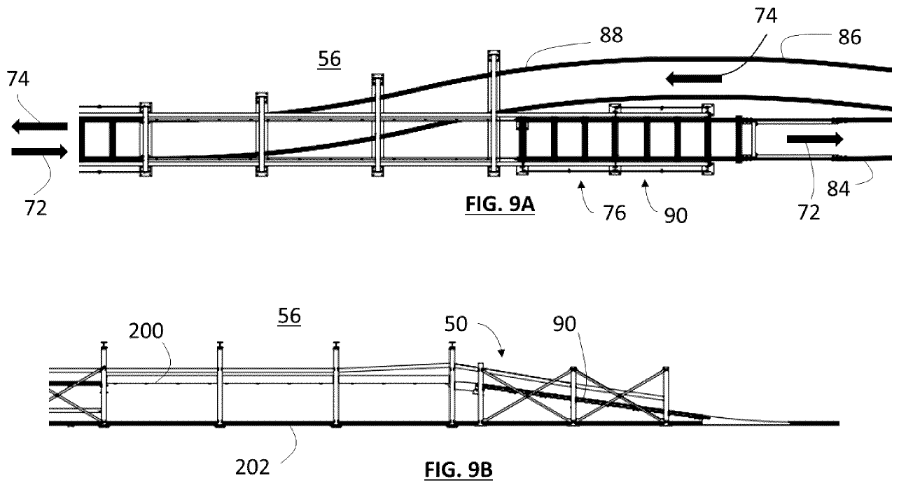

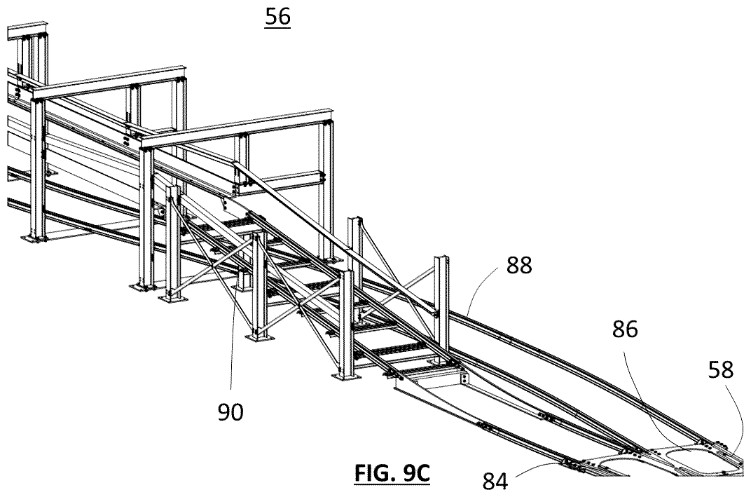

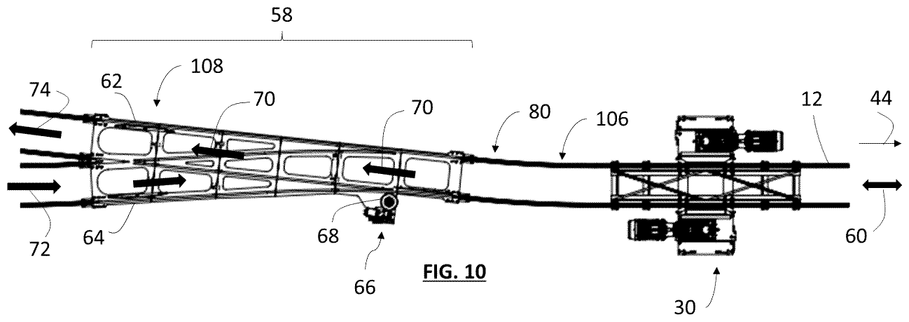

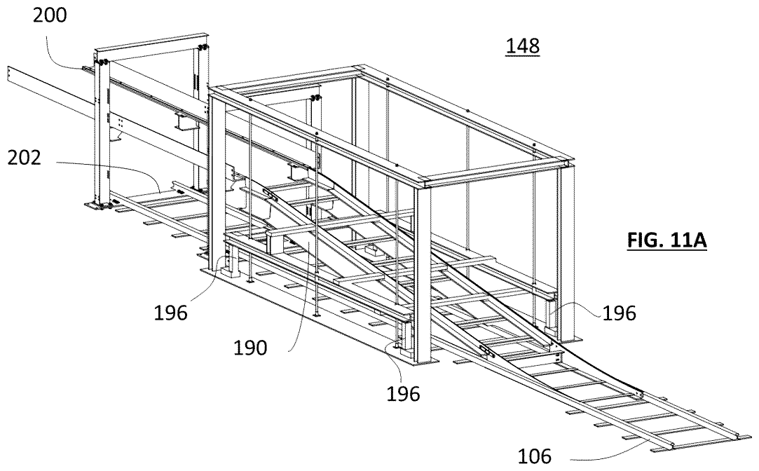

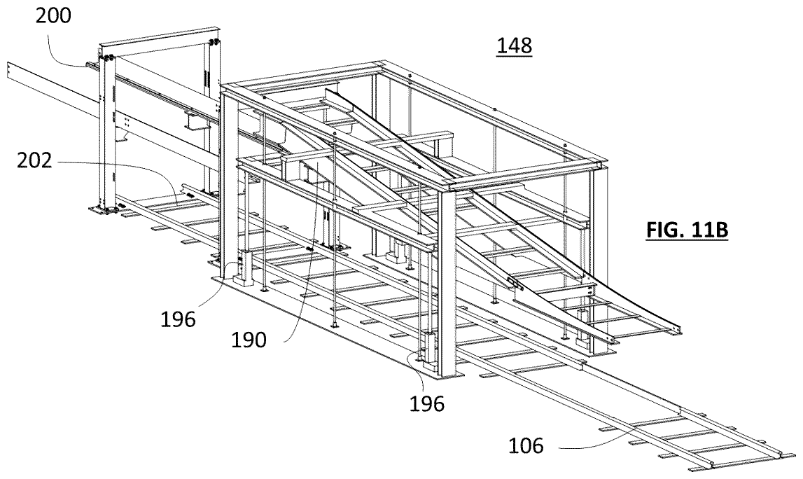

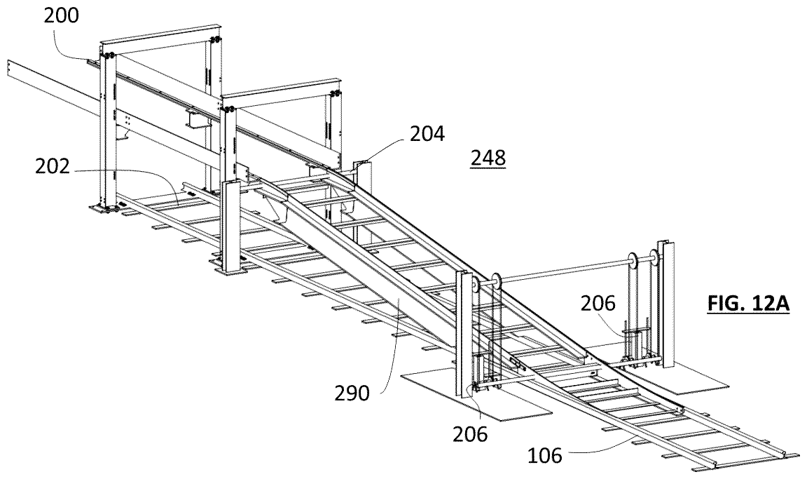

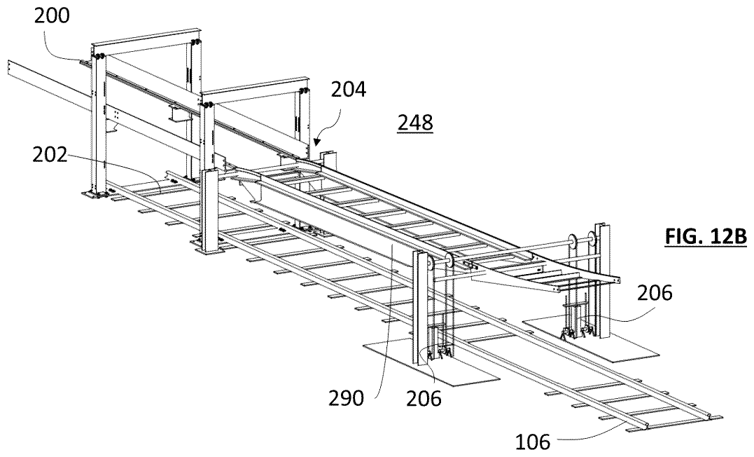

For example, one illustrative arrangement 40 may include: an updrift track switch 48 (FIG. 5) and an updrift end ramp 50 (FIGS. 6A-C and 11-12); a suitable number of drive stations such as bypass drive stations 52 (FIG. 7); and/or bypass dual drive stations 54 (FIG. 8); and a downdrift end ramp 56 (FIGS. 9A-C and 11-12) and a downdrift track switch 58 (FIG. 10) and an upper rail track 200 and a lower rail track 202 (see FIGS. 6B, 7, 8 and 9B). Although horizontal updrift and downdrift track switches are shown, it will be appreciated that one or both switches may be vertical track switches as will be discussed with reference to FIGS. 11-12.

Embodiments of rail bypass arrangements for use with a rail transport system for conveying bulk materials and allowing bypass of a first train and a second train are disclosed herein. Such rail bypass arrangements comprise a lower rail track 202 (FIGS. 6B, 7, 8 and 9B), an upper rail track 200 (FIGS. 6B, 7, 8 and 9B), an updrift track switch in communication with the updrift end of the lower rail track and the updrift end of the elevated upper rail track, the updrift track switch comprising an actuator for guiding a train to either the elevated upper rail track or the lower rail track, a downdrift track switch in communication with the downdrift end of the lower rail track and the downdrift end of the elevated upper rail track, the downdrift track switch comprising an actuator for guiding a train to either the elevated upper rail track or the lower rail track, and at least one drive station positioned between the downdrift track switch and the updrift track switch for moving the first train on the lower track and the second train on the upper track. For example, the rail bypass arrangement may have at least two drive stations, one for the lower track and one for the upper track. In some embodiments a dual drive station may be used which spans both the lower and upper tracks and comprises two drive tires, one for driving a train on the lower track and one for driving a train on the upper track and in an opposite direction. The bypass arrangements may have a suitable number of drive stations to provide the desired amount of drive to the trains. For example, the arrangement may have a single drive station, such as a bypass dual drive station (FIG. 8), or a series of drive stations on the upper and/or lower track. The amount of drive stations may be adjusted to drive trains of different lengths or power requirements.

It will be appreciated that the switches may be horizontal switches which separate or join multiple tracks in a generally horizontally oriented switch or vertical switches which separate or join multiple tracks in a generally vertically oriented switch as will be described in further detail below.

It will be appreciated that reference herein to “in communication” encompasses both direct communication and indirect communication in that further rail or relevant components may be used to indirectly communicate.

Referring to FIG. 5, embodiments of updrift track switch 48 are shown. Updrift switch 48 includes a single track section 106 in communication with a single track 12 for leading to the material collection end or dump area 46 on which trains travel in both directions 60, inward and outward. The updrift track switch 48 also includes an outward track 62 and an inward track 64 side-by-side to each other and on the other end opposite the single track 106 of the switch. The updrift track switch 48 is in communication with the updrift end of a lower rail track 202 of the bypass arrangement and the updrift end of the upper rail track 200 of the bypass arrangement. The updrift track switch 48 comprises an actuator for guiding a train to either the upper rail track or the lower rail track.

Referring to FIG. 5, updrift track switch 48 (or downdrift track switch 58 in FIG. 10) may be a horizontal switch as shown. Horizontal switches may split a single rail into a double rail, or vice versa, in an adjacent or substantially horizontal orientation. Examples of horizontal switches include a side-by-side rail track switch which includes a junction 82 of the two side-by-side inward 64 and outward 62 tracks into a single track 106. A side-by-side rail track junction 82 may be a track junction of a dual rail track 108 into a single rail track 106, or a single track 106 into a dual rail track 108. In updrift track switches 48, the side-by-side rail track junction 82 has the single rail track 106 on the updrift side and the dual rail track 108 on the downdrift side. The dual rail track may comprise an inward rail track 84 in communication with the upper rail track 200 and an outward rail track 86 in communication with the lower rail track 202 of the bypass.

The upper 200 and lower 202 rail tracks allow for two trains, an incoming and an outgoing train, to bypass one another in a substantially reduced footprint as one of the trains passes on the upper rail track substantially above the other train passing on the lower rail track. As such, the upper rail track and the lower rail track must be longer than the length of the trains bypassing each other. In one embodiment, the upper and lower rail tracks are about 1.5 times longer than the trains bypassing each other. An ideal length for the bypass allows the outgoing and incoming trains to bypass one another without stopping or having to alter their speed a significant amount.

Drive station 30 moves the trains as previously described. Actuator 66 may be situated for guiding an inward bound train from the single track to the inward rail track and permitting passage of an outward-bound train from the outward track to the single track. The switch actuator 66, including a wheel 68, allows the single track 12 to communicate with the single track 106 of the switch 48 with the outward and inward tracks 62, 64 on route to the lower track 202 and the elevated upper track 200. In particular, the wheel 68, which may be of smaller size than the previously discussed drive station tires, guides the train to the proper track. The wheel 68 does not need to be a driven wheel in that it does not impart drive to the car that it comes into contact with and so it can have a reduced size as compared to a wheel used in a drive station. By way of example, if the wheel 68 is in its normal retracted (or “in”) position, a train can pass from a dual rail portion 108 of the switch 48 onto the single rail portion 106 of the switch and the wheel does not impact the train. The wheel may be extended, or actuated, to help guide a train in a straight direction through the switch 48 and prevent the train from switching tracks. Accordingly, a train traveling through the switch 66 in an inward direction 72, preferably, but not necessarily, stays on the straight path 70. Accordingly, in this example, the empty train rides inward 72 on the inward track 64 of the switch 48 and eventually to the elevated upper track 200 of the bypass arrangement and the loaded train rides outward 74 from the lower track 202 to the outward track 62 of the switch 48.

Referring to FIGS. 11-12, two examples of a vertical track switch are shown. Each may be used an either an updrift track switch or a downdrift track switch. Vertical switches may split the single rail into a double rail, or vice versa, in a stacked or substantially vertical orientation. Examples of vertical switches include an elevator rail track switch 148 (FIGS. 11A and 11B) and a pivoting rail track switch 248 (FIGS. 12A and 12B).

Referring to FIGS. 11A and 11B, an elevator track switch 148 is comprised of an elevator ramp rail track section 190 which may be raised into an unengaged position and lowered into an engaged position. In such embodiments, the footprint or width of the bypass arrangement is reduced to approximately the width of a single track. The elevator ramp rail track section 190 is shown in the engaged position in FIG. 11A and in the disengaged position in FIG. 11B and is operated between the two positions by an elevating actuator 196. The engaged position may be understood as a position wherein the upper end of the ramp rail track section 190 is in communication with the upper rail track 200 and lower end of the ramp rail track section is in communication with the single rail track 106 allowing for a train to pass from the elevated upper rail track 200, down the ramp 190, to the single track and on to the dump area or extraction area depending on if the elevator track switch is a downdrift or updrift switch. The disengaged position, shown in FIG. 11B, may be understood as a position wherein the ramp rail section 190 is raised upward and disengaged from the single rail track 106 at a height sufficient to allow the train to pass underneath the raised ramp section 190 and onto the lower track 202. Effectively, the single rail track 106 is in constant communication with the lower track 202 so that a train can only engage with the elevated upper track 200 when the ramp section 190 is lowered into the engaged position thereby allowing a train to pass from the single track 106 to the elevated upper track 200 via the ramp section 190. The elevating actuator 196 may be one or more suitable actuators that is suitable for raising the ramp section. For example: hydraulic, pneumatic, pulley, spring, gearing, electric, chain and sprocket, magnetic, or other suitable actuators known in the art.

Referring to FIGS. 12A and 12B, a pivoting rail track switch 248 (which may be used as a updrift track switch or a downdrift track switch) is shown and comprises a pivoting ramp rail track section 290 which may be pivotably raised into an unengaged position (FIG. 12B) and pivotably lowered into an engaged position (FIG. 12A). In such embodiments, the footprint or width of the bypass arrangement is reduced to approximately the width of a single track. The pivoting ramp rail track section 290 may be pivoted between the engaged position and the disengaged position by an actuator 206 which pivots the ramp rail track section 290 about a hinged or pivotal connection 204. The engaged position may be understood as a position the upper end of the ramp rail track section 290 is in communication with the end of the elevated upper rail track 200 and a lower end of the ramp rail track section 290 is in communication with the single rail track 106 thereby allowing a train to pass from the single track 106 to the elevated upper rail track 200 via the engaged ramp track section 290. The disengaged position may be understood as a position wherein the lower end of the ramp rail track section 290 is raised upward and disengaged from the single rail track 106 at a height sufficient to allow a train to pass underneath the raised ramp section 290 and thereby pass onto the lower rail track 202. Effectively, the single rail track 106 is in constant communication with the lower rail track 202 so that a train can only engage with the elevated upper track 200 when the ramp section 290 is lowered into the engaged position thereby allowing a train to pass from the single track 106 to the elevated upper track 200 via the ramp section 290. Actuator 206 may be located at any suitable position to allow pivot at the hinged or pivotal connection 204 and facilitate movement between the engaged position and the disengaged position. The actuator 206 may be one or more suitable actuators that is suitable for pivoting the ramp section 290. For example: hydraulic, pneumatic, pulley, spring, gearing, electric, magnetic, chain and sprocket, or other suitable actuators known in the art.

It will be appreciated that the vertical switches described herein may be used as a substitute to for one or both horizontal switches described herein within the bypass arrangement.

FIGS. 6A-6C illustrate an embodiment of updrift end ramp 50 in communication with the side-by-side rail track junction 82. Updrift end ramp 50 may have a ramp rail track section 90 in communication with the upper rail track 200 of the bypass arrangement and the inward rail track 84 of the updrift switch 48. The updrift end ramp 50 may have a curved rail track section 88 in communication with the lower rail track 202 and the outward rail track 86 of the updrift switch 48 for side-by-side bypass of the ramp rail section 90 and the lower rail track 202. In such embodiments, the ramp rail section 90 may be securely connected to the upper rail track 200 and the inward rail track 84 of the updrift switch 48. The secure connection may be such that the ramp does not substantially move in operation. Curved rail track section 88 may have rail tracks curved to pass around the ramp rail section 90 and below the upper track 200.

In an illustrative example (FIGS. 6A-6C), a loaded train travels outward 74 on lower track 202 of the bypass to the outward track 62 of the switch 48 and an empty train is traveling inward 72 via the inward track 64 of the switch 48 and onto the upper track 200. On the extraction site side of the ramp the loaded train will travel outward 74 on the lower level track 202 and the empty train will travel inward 72 on the elevated upper track 200. As the lower track 202 is positioned on the ground, it can more easily carry the heavy load of a loaded outward bound train.

Drive stations are positioned along the length of the bypass between the updrift end and the downdrift end to drive trains on the upper track 200 and the lower track 202. The type and quantity of such stations will depend, among other things, on the length of the trains being utilized as well as the particular terrain or topography of the location from extraction to collection for the specific application. Turning back to the example arrangement 40 of FIG. 4, three bypass drive stations 52 and two bypass dual drive stations 54 have been utilized. In particular, FIG. 7 illustrates an example of a suitable bypass train station as a single drive station 30 for driving the loaded train traveling outward 74 on the ground level lower track 202 and does not engage with, i.e. bypasses, the empty train traveling inward 72 on the elevated upper track 200. FIG. 8 illustrates another example of a suitable bypass drive station as a dual drive station 54 having a drive station 30 for driving the loaded train travelling outward 74 on the ground level lower track 202 and an elevated drive station 78 for driving the empty train traveling inward 72 on the elevated upper track 200. It will be appreciated that although the two drive stations are shown as being separate drive stations it is contemplated that the lower drive station 30 and the elevated drive station 78 may be integrated together in the dual drive station 54.

FIGS. 9A-9C illustrate an embodiment of the downdrift end ramp 56 in communication with side-by-side (also referred to as a horizontal) rail track junction of the downdrift switch 58. In this example, the empty train is traveling inward 72 on an elevated upper track 200 and the loaded train is traveling outward 74 on the ground level lower track 202. On the extraction site side of the ramp 76 the loaded train will travel outward 74 and the empty train will travel inward 72.

Referring to FIGS. 9A-C, downdrift end ramp 56 may have a ramp rail track section 90 in communication with the upper rail track 200 and the inward rail track of the downdrift switch 58. The downdrift end ramp 56 may have a curved rail track section 88 in communication with the lower rail track 202 and the outward rail track 86 of the downdrift switch 58 for side-by-side bypass of the ramp rail section 90. In such embodiments, the ramp rail section 90 may be securely connected to the upper rail track 200 and the inward rail track 84 of the downdrift switch 58. The secure connection may be such that the ramp does not substantially move in operation. Curved rail track section 88 may have rail tracks curved to pass around the ramp rail section 90 and below the upper track 200.

Referring to FIG. 10, a side-by-side rail track junction of a downdrift track switch 58 is shown. Side-by-side rail track junction may be a track junction of a dual rail track 108 into a single rail track 106, or a single track 106 into a dual rail track 108. In downdrift track switches, the side-by-side rail track junction has the single rail track on the downdrift side and the dual rail track on the updrift side. The dual rail track 108 may comprise an inward rail track 64 in communication with the elevated upper rail track 200 and an outward rail track 62 in communication with the lower rail track 202 of the bypass.

As shown in FIG. 10, downdrift track switch 58, which may also be referred to as a horizontal switch, includes an outward track 62 on which a train may move in an outward direction 74 to a dump area and an inward track 64 on which a train may move in an inward direction 72 to an extraction area. The outward and inward tracks for a dual rail track 108 on the collection site side and join to form a single track 106 on the extraction side 44 in communication with a single track 12 where trains travel in both directions 60 to and from the extraction area. A drive station 30 moves the trains as previously described. A switch mechanism 66, including a wheel 68, allows the single track 12 to communicate with the outward and inward tracks 62, 64 and eventually the lower track 202 and the elevated upper track 200, respectively. In particular, a loaded outward train traveling through the switch 66 may travel on tracks having a slight curve 80 to stay on a straight path 70 to the lower track 202 and eventually to the dump area. Accordingly, in this example, the loaded train rides 74 on the outward track toward the dump site and the empty train arrives 72 from the upper track 200 on the inward track 64 and drives toward the extraction side.

Drive station 30 moves the trains as previously described. Actuator 66 may be situated for guiding an inward bound train from the single track to the inward rail track and permitting passage of an outward-bound train from the outward track to the single track. The switch actuator 66, including a wheel 68, allows the single track 12 to communicate with the upper and lower tracks 62, 64. In particular, the wheel 68, which may be of smaller size than the previously discussed drive station tires, guides the train to the proper track. The wheel 68 does not need to be a driven wheel in that it does not impart drive to the car that it comes into contact with and so it can have a reduced size as compared to a wheel used in a drive station. By way of example, if the wheel 68 is in its normal retracted (or “in”) position, a train can pass from a dual rail portion of the switch onto the single rail portion of the switch and the wheel does not impact the train. The wheel may be extended, or actuated, to help guide a train in a straight direction through the switch and prevent the train from switching. Accordingly, a train traveling through and facing the switch 66 preferably, but not necessarily, stays on the straight path 70. Accordingly, in this example, the empty train rides inward 72 on the inward track 64 and the loaded train rides outward 74 from the outward track 62 of the downdrift switch 58.

The actuators described herein, whether for the side-by-side switch or the ramp style switch (both elevator and pivoting as described with reference to FIGS. 11 and 12), may be controlled with a program logic controller which monitors the status of the trains on the tracks. The PLC may also control the speed of the trains, the direction of travel and preferably also controls the operation of the actuators in the arrangement and within the rail system. The PLC can then determine if two trains need to bypass one another and can control the actuators and the speed of the trains to ensure that the trains bypass each other safely. In one embodiment, a loaded train used directed to the lower rail track while an unloaded train is directed to the upper rail track of the bypass. Typically, the loaded train or outgoing train, bypasses the unloaded or incoming train on the bottom rail track so that the lighter of the two bypassing trains uses the upper rail track. Once example of a suitable PLC and/or controller is described with reference to U.S. Pat. Pub. No. 2018/0186384 to Fisk et al. (incorporated herein by reference in its entirety) describes a control system for an improved rail transport system for conveying bulk materials.

In such a setup, where the unloaded train is guided to the upper rail track of the bypass, the bracing and construction may be simplified to accommodate a lighter train while if the loaded train is guided to the upper rail track, the upper rail track must be reinforced to handle the additional weight of a loaded train.

It will be appreciated that a plurality of braces may be used to reinforce, support and maintain the spacing and shape of the bypass arrangement. Further, any number and orientation of the bracing may be implemented to reinforce, support and maintain the upper and lower tracks as is needed based on the intended speed and weight of the trains and the weight of the intended load to be carried. Further still, bracing components, connectors or mounts, as described or inferred herein are merely illustrative of examples of bracing components, connectors or mounts that may be incorporated into the rail sections to allow for reinforcing, supporting, and maintaining the spacing and shape of the rails and connections to each other or to legs or leg extensions. The placement and number of bracings, connectors or mounts may be altered, increased, or reoriented without departure for the teachings of the disclosure. For example, suitable bracing materials include structural steel angle, steel straps and other materials known in the art.

Described herein are various over-under bypass systems for conveying bulk materials that can form part of a rail transport system. It will be appreciated that embodiments, illustrations, and examples are provided for illustrative purposes intended for those skilled in the art and are not meant to be limiting in any way. Various modifications, amendments, revisions, substitutions, and changes may be made to the bypass that are within the scope and spirit of the teachings of the disclosure.

Indeed, the foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A rail bypass arrangement for use with a rail transport system for conveying bulk materials and allowing bypass of a first train and a second train, the rail bypass arrangement comprising:
a lower rail track having a downdrift (extraction) end and an updrift (collection) end;
an upper rail track having a downdrift (extraction) end and an updrift (collection) end;
an updrift track switch in communication with the updrift end of the lower rail track and the updrift end of the upper rail track, the updrift track switch comprising an actuator for guiding a train to either the upper rail track or the lower rail track;
a downdrift track switch in communication with the downdrift end of the lower rail track and the downdrift end of the upper rail track, the downdrift track switch comprising an actuator for guiding a train to either the upper rail track or the lower rail track; and
a first drive station positioned between the downdrift track switch and the updrift track switch for moving the first train on the lower track and a second drive station positioned between the downdrift track switch and the updrift track switch for moving the second train on the upper track.

2. The rail bypass arrangement of claim 1, wherein the updrift track switch further comprises:
a side-by-side rail track junction of a dual rail track into a single rail track having a downdrift side and an updrift side, the updrift side having the single rail track, the downdrift side having the dual rail track, the dual rail track comprising an inward rail track in communication with the upper rail track and an outward rail track in communication with the lower rail track,
the actuator situated for guiding an inward bound train from the single track to the inward rail track and permitting passage of an outward bound train from the outward track to the single track.

3. The rail bypass arrangement of claim 2, wherein the rail bypass arrangement further comprises:
a ramp rail track section in communication with the upper rail track and the inward rail track of the updrift switch; and
a curved rail track section in communication with the lower rail track and the outward rail track of the updrift switch for side-by-side bypass of the ramp rail section, the curved rail track section having rail tracks curved to pass around the ramp rail section and below the upper track.

4. The rail bypass arrangement of claim 1, wherein the downdrift track switch further comprises:
a side-by-side rail track junction of a dual rail track into a single rail track having a downdrift side and an updrift side, the downdrift side having the single rail track, the updrift side having the dual rail track, the dual rail track comprising an inward rail track in communication with the upper rail track and an outward rail track in communication with the lower rail track,
the actuator situated for guiding an outward bound train from the single rail track to the outward rail track and permitting passage of an inbound train from the inward track to the single track.

5. The rail bypass arrangement of claim 4, wherein the rail bypass arrangement further comprises:
a ramp rail track section in communication with the upper rail track and the inward rail track of the downdrift switch; and
a curved rail track section in communication with the lower rail track and the outward rail track of the downdrift switch for side-by-side bypass of the ramp rail section, the curved rail track section having rail tracks curved to pass around the ramp rail section and below the upper track.

6. The rail bypass arrangement of claim 1, wherein the updrift track switch comprises:
a lower rail track section having a downdrift end in communication with the updrift end of the lower rail track and an updrift end in communication with a single rail track; and
an elevator ramp rail track section moveable between:
1) an engaged position wherein a downdrift end of the ramp rail track section is in communication with the updrift end of the upper rail track and an updrift end of the ramp rail track section is in communication with the single rail track; and
2) a disengaged position wherein the ramp is raised upward and disengaged from the single rail track at a height sufficient to allow the train to pass underneath the raised ramp section, and
wherein the ramp rail section moves between the engaged and disengaged positions via an elevating actuator in connection with the ramp section.

7. The rail bypass arrangement of claim 6, wherein the elevating actuator is one or more of: a hydraulic, pneumatic, pulley, spring, gearing, electric, chain and sprocket, or magnetic actuator.

8. The rail bypass arrangement of claim 1, wherein the downdrift track switch comprises:
a lower rail track section having an updrift end in communication with the downdrift end of the lower rail track and a downdrift end in communication with a single rail track; and
an elevator ramp rail track section moveable between:
1) an engaged position wherein an updrift end of the ramp rail track section is in communication with the downdrift end of the upper rail track and a downdrift end of the ramp rail track section is in communication with the single rail track; and
2) a disengaged position wherein the ramp is raised upward and disengaged from the single rail track at a height sufficient to allow the train to pass underneath the raised ramp section, and
wherein the ramp rail section moves between the engaged and disengaged positions via an elevating actuator in connection with the ramp section.

9. The rail bypass arrangement of claim 8, wherein the elevating actuator is one or more of: a hydraulic, pneumatic, pulley, spring, gearing, electric, chain and sprocket, or magnetic actuator.

10. The rail bypass arrangement of claim 1, wherein the updrift track switch comprises:
a lower rail track section having a downdrift end in communication with the updrift end of the lower rail track and an updrift end in communication with a single rail track; and
a pivoting ramp rail track section moveable between:
1) an engaged position wherein a downdrift end of the ramp rail track section is in communication with the updrift end of the upper rail track and an updrift end of the ramp rail track section is in communication with the single rail track; and
2) a disengaged position wherein the updrift end is raised upward and disengaged from the single rail track at a height sufficient to allow a train to pass underneath the raised ramp section, and
wherein the ramp rail section is connected to the upper track section with a hinged or pivotal connection that allows movement between the engaged position and the disengaged position.

11. The rail bypass arrangement of claim 10, wherein the movement is executed by one or more of a hydraulic actuator, pneumatic actuator, pulley actuator, spring actuator, gearing actuator, electric actuator, chain and sprocket actuator, or magnetic actuator.

12. The rail bypass arrangement of claim 1, wherein the downdrift track switch comprises:
a lower rail track section having an updrift end in communication with the downdrift end of the lower rail track and a downdrift end in communication with a single rail track; and
a pivoting ramp rail track section moveable between:
1) an engaged position wherein an updrift end of the ramp rail track section is in communication with the downdrift end of the upper rail track and a downdrift end of the ramp rail track section is in communication with the single rail track; and
2) a disengaged position wherein the downdrift end is raised upward and disengaged from the single rail track at a height sufficient to allow a train to pass underneath the raised ramp section, and
wherein the ramp rail section is connected to the upper track section with a hinged or pivotal connection that allows movement between the engaged position and the disengaged position.

13. The rail bypass arrangement of claim 12, wherein the movement is executed by one or more of a hydraulic actuator, pneumatic actuator, pulley actuator, spring actuator, gearing actuator, electric actuator, chain and sprocket actuator, or magnetic actuator.

14. (canceled)

15. (canceled)

16. (canceled)

17. The bypass arrangement of claim 1, wherein the upper rail track is adapted to accommodate an inward or unloaded train, and the lower rail track is adapted to accommodate the outward or loaded train.

18. The bypass arrangement of claim 1, wherein the upper rail track and the lower rail track are each about 1.5 times longer than a length of a train for using the bypass.

19. The bypass arrangement of claim 1, wherein the actuators and/or the switches are controlled by a program logic controller.

20. The bypass arrangement of claim 19, wherein the program logic controller also controls the operation of the drive stations to control the speed of the trains in the system.

21. The bypass arrangement of claim 1, wherein the first drive station and the second drive station are comprised in a dual drive station.

22. The bypass arrangement of claim 21, wherein the dual drive station is an integrated dual drive station with the first and second drive stations mounted vertically above one another.

23. A rail transport system for conveying bulk materials on a rail track comprising:
a first train,
a second train, and
a bypass arrangement as defined in any one of claims 1 to 22 for permitting the first train to bypass the second train on an upper and a lower track of the bypass arrangement.
